(19) United States
(12) Patent Application Publication
(10) Pub. No.: US 2005/0236447 A1
(43) Pub. Date: Oct. 27, 2005

(54) Portable Transport Suspender Halter For Laptop Or Notebook Type Computers

(76) Inventor: Richard Evans Monivis, Miami, FL (US)

Correspondence Address: Richard Evans Monivis, 10351 S.W. 64 Street, Miami, FL, 33173, US

(21) Appl. No.: 10/708,913

(22) Filed: Mar. 31, 2004

(51) Int. Cl. G06F 1/16

(52) U.S. Cl. 224/275

(57) ABSTRACT

An economical lightweight portable Laptop or Notebook Computer holder that can easily, without tools, be attached to most vehicles both public and private (Photos #1,2,7,8,9). It is versatile enough to easily be moved to different places in a vehicle for other users (Photos#7,8,9). The straps and base are made of a strong and durable yet soft and flexible material (Photo #15). Its design provides for proper air circulation and cooling (Photo #5) as well as access for plug in accessories (Photo#6). In addition to holding a computer in a transportation vehicle it can be worn by a person and hold a portable computer for use while walking or standing (Photos#13,14). This same holder can easily convert to a computer carrier with a handle or shoulder strap (Photo#11,12). Additionally this same holder can be used as a Desk Work Area or a Child's Play Station (Photo#2,10).

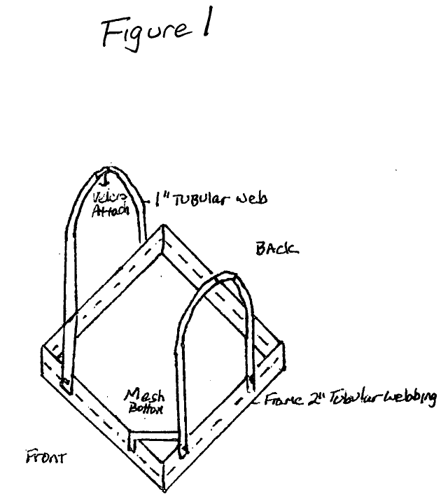

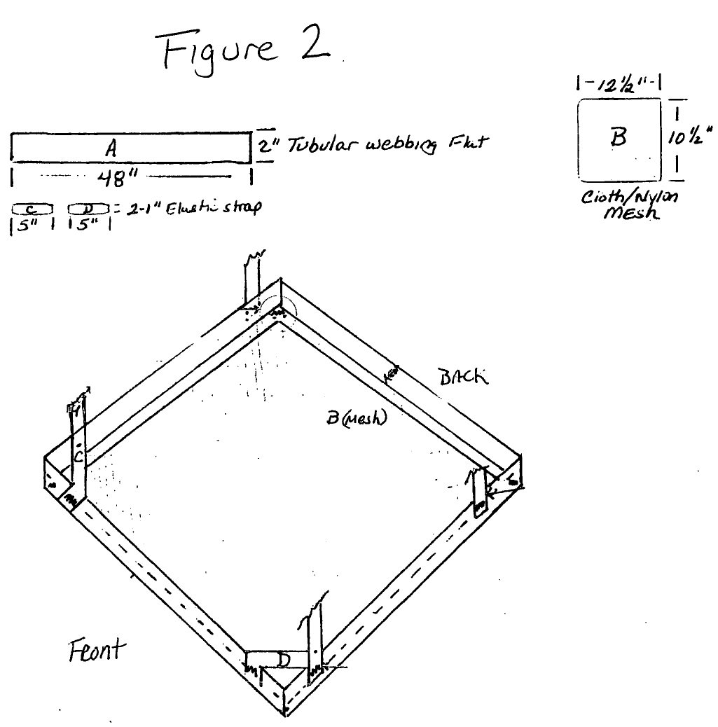

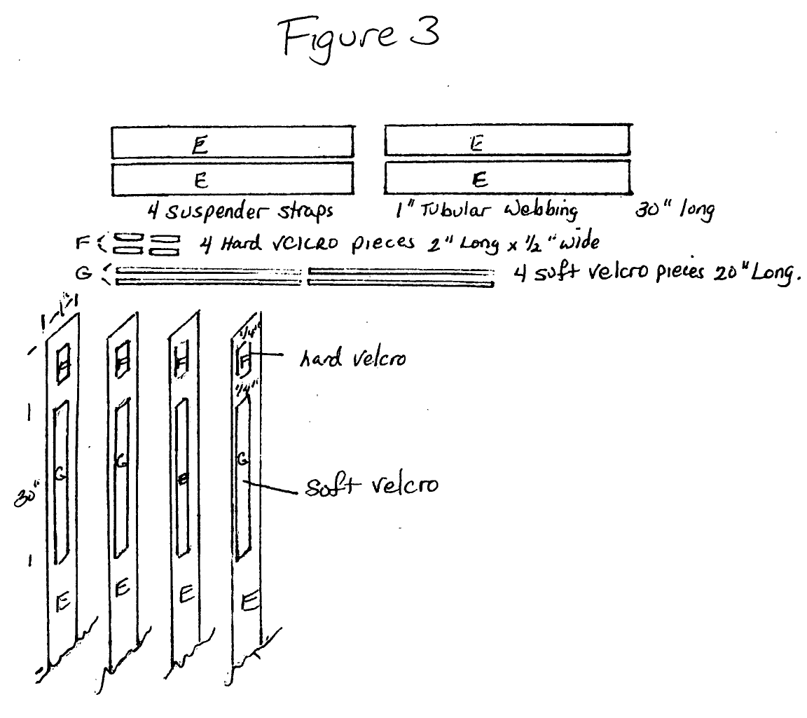

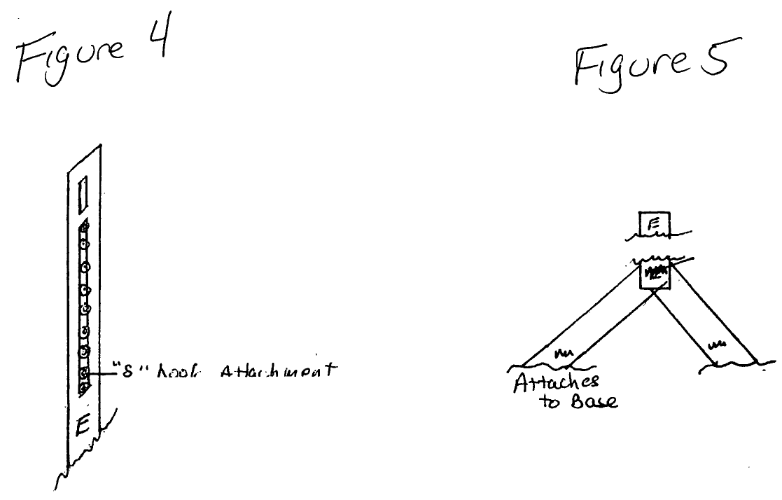

### CROSS REFERENCE TO RELATED APPLICATIONS

Not applicable.

### BACKGROUND OF INVENTION

1. Field of Invention

This invention relates to a laptop or notebook computer holder that is soft and compactable, easily mounted or removed without tools, securely holds a computer in most vehicles and can be worn on a person while being used, while allowing heat to escape so the computer operates cooler and allows access for accessories such as chargers and the like to be plugged in, and can be converted to a shoulder strap carrier for the computer. When the computer is not in the holder it can be used as Child Play Station or Desk Work Area in most vehicles.

2. Description of Prior Art

This invention was developed primarily to enable a user to use a portable computer in a car, S.U.V., bus, plane, and like transportation with a seat or steering wheel that a computer can be suspended from with freedom, peace of mind, and flexible versatility. Something not found in previous products on the market today. Although I have not found products that can be compared to this invention, prior products exist to mount a computer in a vehicle.

The portable computer referred to as the laptop or notebook computer has enabled people to bring their computers virtually everywhere. More and more laptops and notebooks are being used as they are being built more powerful and are more affordable than ever before.

Using a portable computer in a vehicle has an inherent danger of damage whether being used by a driver who has stopped and then must drive on, or being used by a passenger (co-worker or teen child) also when used on a public conveyance when there is a need for the user to get up and move around. There is a high probability that damage can occur to the laptop or notebook computer in several ways:

1). Starting, stopping, turning, can cause the computer to slide off onto the floor or cause some other item to fall onto the device. This very likely can cause damage to lids, L.E.D., case, and/or keyboard.

2). The same movements can also cause plugs such as a charger, USB or PCMCIA card to brake off.

Another problem with using a laptop or notebook computer as with all electronic devices is heat. Most laptops and notebooks are built with internal fans and have rubber feet built onto the base to allow for proper air circulation. When traveling, a lap or seat or book bag doesn't allow for heat to dissipate as it would if the computer was placed on a flat surface. The improper air circulation may adversely affect the computer.

Certainly the above is a lot for the person responsible for such an expensive device to contend with. For example the parent driving their SUV would worry about their teen in the back seat using the laptop. This could be distracting. If the computer were secured to a seat then the risk of damage would be reduced as well as the distraction.

There are only a couple of methods of securing a laptop or notebook computer in a vehicle. One that comes to mind is a permanent mount similar to that used by police departments in patrol vehicles. However, there are several drawbacks to that type of apparatus.

1). Not portable.

2). Very costly.

3). Generally can only be installed by a professional with tools and equipment and not a layperson.

4). Certainly limited usage by only one person. Can't be moved to another part of the vehicle for another person to use it.

Another method I read about but have not seen was portable, had a weighted base and a telescopic arm. However the disadvantages would be:

1). Bulky and difficult to store and make portable.

2). Expensive.

3). Requires some assembly and perhaps some tools.

4). Limited flexibility.

The “Portable Transport Suspender Halter For Laptop Or Notebook Type Computers” resolves the above problems and disadvantages and much more. This will be discussed later under Objects and Advantages.

### SUMMARY OF INVENTION

Summary:

As the use of the portable computer has increased and specifically with regard to mobility and travel the need for a functional inexpensive way to use the device is present. Prior Art does not accomplish this. This invention does by offering virtually effortless mounting, a secure mount for the computer, inexpensive, almost limitless flexibility, and is lightweight and very portable.

### OBJECTS AND ADVANTAGES

The objects and advantages over prior art are numerous. Accordingly several objects and advantages are:

1). This invention is constructed with a soft garment like material. The model was made with tubular webbing. This material is generally used to tie down cargo and as a harness to support a man/women weight for climbing. A like strap can be used. It is pliable and lightweight. This invention is strong and durable enough to support a portable computer and yet can be folded or crumbled up to be stored as one would a pair of socks. This is quite an advantage over the prior art. Like a pair of socks, this invention can be carried on airplanes without problems at security check in. This makes for a very light and very portable support or holder for the computer.

2). This invention is much less expensive than prior art. The cost of the material and process to manufacture is minimal as compared to prior art.

3). This invention requires no assembly. To attach it to a vehicle for use is as simple as looping a strap over a bucket seat or bench seat headrest, or wrapping the straps around the vehicle seat and pressing two pieces of Velcro together. Unlike prior art virtually anyone can do it, a professional, a housewife, or a teen. No tools are required.

4). Unlike prior art this invention's flexibility and versatility is considerable.

a). It can be attached to most automobile, SUV, and truck seats. It can support securely a computer on a front passenger seat facing the driver so the driver can use the computer when stopped and then drive on without moving the computer and any plug in accessories to the side. The computer would also have proper air circulation because it would be suspended in air and the bottom of the base has the mesh cloth. The computer could then easily and quickly be moved to the front seat (passenger or driver side) facing the back seat for use by another person in the vehicle (such as a teen wanting to do homework or go onto the Internet). It could also be moved to the back seat facing the side (driver or passenger side). In addition to the numerous placements in the vehicle and use by different people the two hanging straps allow for the computer to be tilted, or angled, or adjusted to a height compatible to the user.

b). Should the user need to travel and take a bus, train, or plane this invention can be attached to the seat in front of them, support their computer for use, so should the need arise for the user to get up it would not be necessary to find a place to set the computer or close it up. They could just take their break and return to their activity without disruption.

c). This invention can easily convert to a portable computer carrier by laying the front straps along the side of the computer and wrapping the rear straps around the unit. This allows the user to hang the computer flat along the seat it's attached so it is out of the way or hang it on the users shoulder for carrying. This additional flexibility/versatility is an advantage over prior art.

d). When the computer is not in this invention a cloth covered foam insert can be placed into the frame allowing this invention to be used as a child play station while hung on a seat next to a child restraint seat. The soft insert and soft material of this invention makes for a safer item in a vehicle when a child is moving around or getting in or out of the vehicle, also an advantage over prior art.

e). The same insert as described above in d) can be used by an adult as a deskwork area, another advantage over prior art.

f). This invention can be made in a variety of colors, another advantage over prior art.

g). A user can also wear this invention allowing use of the computer secured to the person while sitting, standing or walking, Another advantage over prior art.

### BRIEF DESCRIPTION OF DRAWINGS

Drawing # 1 shows a three-sided view of this invention, the top, front, and right side. This illustrates the frame, mesh bottom, suspending straps, and elastic corner straps.

Drawing # 2 is a three-sided view of the base as well as a single dimensional view of its components labeled A, B, C, and D.

Drawing # 3 shows the suspender straps and the component materials to construct them. The components are labeled E, F, and G.

Drawing # 4 and # 5 shows a future variation of the suspender strap should the portable computer manufactures fashion a latch for the straps to be hooked directly to the computer base.

Photo # 1 shows a laptop computer with the lid open suspended from the front seat of a popular S.U.V. (2003 Ford Explorer) facing the driver ready for use.

Photo # 2 shows the same as photo #1 with the lid of the computer closed depicting a deskwork area.

Photo # 3 shows the rear view of the laptop suspended form the front seat of the S.U.V. Taken to show accessibility to plug accessories into the laptop.

Photo # 4 same as photo # 3 with lid open.

Photo # 5 is the under side view and back of the laptop to show the mesh bottom that allows for heat to dissipate and at the left back that the cooling fans are exposed.

Photo # 6 shows the back view with the lid open and accessories plugged in.

Photo # 7 shows the laptop suspended from the backseat front view facing the passenger side ready for use.

Photo # 8 shows from a side view the laptop suspended from the back seat facing the front of the vehicle.

Photo # 9 shows from a front/side view of the laptop suspended from the front passenger seat facing the back passenger seat ready for use.

Photo # 10 same view as photo # 9 with the lid closed to illustrate its use as a child play station or deskwork area.

Photo # 11 front view of the suspender as a laptop carrier.

Photo # 12 rear view of photo # 11.

Photo # 13 view of the suspender being worn by a person.

Photo # 14 view of the suspender being worn by another person.

Photo # 15 shows view of the suspender's pliable nature laid out on a flat surface.

Photo # 16 another view on a flat surface with a computer next to it for reference point.

### BRIEF DESCRIPTION OF SEQUENCES

Not Applicable.

### DETAILED DESCRIPTION

Description of Invention:

Drawing #1 is a perspective view of my “Portable Transport Suspender Halter For Laptop Or Notebook Type Computers”. The working model was constructed from the specifications shown. Photos #15 and #16 are of the actual working model.

The Suspender is comprised of four types of cloth materials. Drawing #2 shows the construction of the base. Although the size will vary to fit all brands and models, this base was designed to fit a Laptop Computer with a 15″ screen. First a 48″ piece of 2″ tubular webbing strap was cut and the ends heated to keep the material from unraveling. Although a like material can be used, the tubular webbing strap was used for its strength, durability, and flexibility. Then the ends were stitched together with a strong stitch. The next step is to create a base for the computer to rest on. The computer was placed on a flat surface and the 2″ webbing is placed around the frame. The corners were marked and cut to allow for a corner to be created. A 1″ vertical cut was made. The cut pieces are then overlapped and a durable stitch was sewn. This caused the flat webbing to bend and provide a bottom on the base for the computer frame to rest on. A cloth mesh square was cut and placed on the top side of the bottom of the base and sewn in place as shown. The mesh allows for heat to dissipate and proper air circulation for a cooler operating environment for the computer. Two elastic cloth straps were then sewn over the front corners of the base to hold the front of the computer in place. Elastic was used to allow for the lid to be opened and closed without removing the computer from the base. I myself preferred using the 1″ tubular webbing for strength however the elastic strap would be a little more user friendly for the general population.

The construction of the straps are shown in Drawing #3.

As shown for this model four 1″ tubular webbing straps are cut 30″ long. The length is needed to provide the ability to use this invention in the various places in the vehicles and persons as well as a shoulder carrying case. Velcro is sewn to the straps. The hard Velcro 2″ long is used near the end of each strap and a 20″ long piece of the soft Velcro is sewn on each strap as shown. This allows for adjustability and versatility. The straps are then attached to the base as shown in drawing #2.

Drawings #4 and #5 represent alternate versions of the strap. Drawing #4 is built the same as # 3 with an addition of small metal eyeholes. This design allows for a hook to be fastened at the end of a strap by sliding the strap through the end of a hook and folding the end of the strap and pressing the Velcro together. This allows the user to adjust the height of the front or back of the computer differently than drawing #3 version. Drawing #5 represents a version that can be used as in previously described. This version uses only two straps with two smaller straps connecting it to the base.

### OPERATION OF INVENTION

The completed working model is shown in Photos #15 and #16. The soft pliable nature of the materials allows this invention to be stored as one would a pair of socks. It can be folded or bunched up and put in an auto's console or glove box. It is small enough to fit in some ones pocket or a small pocket in luggage or even a briefcase. This makes the invention easily portable.

To be used in its primary purpose, in a vehicle, photo #1 shows the computer suspended from the front bucket seat of a popular SUV. One would fit the computer into the base with the front corners under the two elastic corner straps. The back corners should fit snug around the back corners of the computer. The two side straps are wrapped around the headrest (they are long enough to wrap around the seat) and the Velcro ends are pressed together. With the computer facing the driver the other two straps are also secured around the headrest. This secures the computer to the vehicle seat and is ready for use.

If someone needed to have a small work area for papers, note pads and the like, just close the cover. This is shown in Photo #2.

Photos #3, #4, and #6 show the computer while attached allows the user access to plug in a charger or other accessories that the computer is equipped for.

Photo #5 shows the underside of the invention. It's supposed to show the mesh that won't trap heat and allow the computer to have proper air circulation. It also acts as a dust filter for the computers that have a fan designed to suck air from the underside of the computer for cooling.

If someone other than the driver such as a teen or coworker wanted to use a computer, this same invention is flexible to accommodate that use. Photos #9 and #10 shows the computer attached to the rear side of the front bucket seat. The computer is put into the base in the same manner as described above. However, instead of connecting the side straps together, the front and rear straps would be connected in the same fashion as described earlier. The angle and tilt can be adjusted, as needed depending on how long or short the straps are fastened. With the lid closed the suspender can be used as a small work area for someone to use. For a child to use as a play station a cloth covered piece of foam will be offered. It would be the same size as the computer and would be inserted in place of the computer when the invention is used for that purpose. This would avoid the potential of a child bumping into the hard corners of a computer when moving around or getting in and out of the vehicle.

Photos #7 and #8 shows the additional flexibility of the invention. It can be attached to the rear seat of a vehicle facing the front or side.

The invention can also be used as a carrying case. Photos #11 and #12 shows this. With the computer in the base and placed on a flat surface the front straps should be placed along the sides of the computer toward the back and connected together with the Velcro. Then the two rear straps should be wrapped around the computer and the front straps along the side. As shown the carrier can hold the computer by hand or under a shoulder.

This same invention addition versatility is shown in photos #13 and #14. To wear the computer and allow for hands free holding is as easy as putting the side straps over ones shoulder.

It should also be noted as its use that the straps alone work in the same fashion without the base when it can be developed that the computer manufacturers build their frames with a hook type design as part of the computers frame. Then the straps can be attached directly to the frame and used in the same fashion as described above.

### CONCLUSIONS, RAMIFICATIONS, AND SCOPE OF INVENTION

After reading the descriptions the reader can summarize that the Portable Transport Suspender Halter For Laptop/Notebook Computers is a unique apparatus with various uses even though it's primary use is to securely hold a laptop or notebook computer.

First it is lightweight and portable.

Second it can be set up for use and removed with ease by virtually anyone.

Third it can aid a user of a portable computer to operate it in an environment allowing for proper air circulation.

Fourth it provides access to plug in accessories that the computer is equipped for.

Fifth it allows a computer to be set up for one user then easily set up in another part of the vehicle for another user. (For example during the day I use the computer suspended from the front bucket seat facing the drivers seat. When I pick up my two children I set the computer up on the back of the front seat facing the back seat. My daughter does her homework and accesses the internet while I attend my sons sports activity.).

Sixth it provides for considerable piece of mind for the person responsible for the computer as when used in the above example the possibility of accessory plugs breaking or other damage is reduced.

Seventh the long straps provides for adjustment of height, angle, or numerous compatible positions.

Eight the long straps also make it possible to attach the suspender to various sized seats allowing the user to use their computer in other means of transportation such as buses, planes, or trains.

Ninth it has other uses when not used for the computer. The deskwork area or child play station.

Tenth and certainly not its last use it can be easily converted to carry the computer securely.

Eleventh one can wear this invention, support a computer and be able to move around if desired.

The invention is not limited to the above. The future may hold a use for the straps themselves if the computer manufacturers fashion a hook that the straps can be attached. Certainly that is something that will be pursued. However, to use this form of attachment is unique at the present time.

1. A lightweight portable laptop/notebook computer or like device holder that suspends said type device from an automobile seat, aircraft seat, or bus seat, or like support, in a usable position.

2. The suspender of claim 1 provides attachment or removal easily without tools.

3. The suspender of claim 1 is adjustable with regard to height or angle of the suspended device.

4. The suspender of claim 1 is comprised of soft, flexible, and durable cloth type material.

5. The suspender of claim 1 is convertible to be worn by a person while suspending a laptop/notebook computer or like device for use.

6. The suspender of claim 1 is convertible to a laptop/notebook computer or like device carrier with a handle or shoulder strap.

7. The suspender of claim 1 provides for proper air circulation and heat dissipation.

8. The suspender of claim 1 provides for accessories to be plugged into the laptop/notebook computer or like device.

9. The suspender of claim 1 is convertible to provide a deskwork area.

10. The suspender of claim 1 is convertible to provide a child play area.

11. The method of suspending a laptop/notebook computer or like device as claimed in claims #1 thru 8 using straps connected to a base to hold said device.

12. The method of claim 11 connecting straps directly to said devices frame.
